(19) United States
(12) Patent Application Publication
(10) Pub. No.: US 2019/0011073 A1
(43) Pub. Date: Jan. 10, 2019

(54) FLUID FLOW VALVE

(71) Applicant: A.R.I. FLOW CONTROL ACCESSORIES LTD., D.N. Ramat Hagolan (IL)

(72) Inventor: Itzhak OGEN, Kiryat Tivon (IL)

(73) Assignee: A.R.I. FLOW CONTROL ACCESSORIES LTD., D.N. Ramat Hagolan (IL)

(21) Appl. No.: 15/747,863

(22) PCT Filed: Jul. 17, 2016
(86) PCT No.: PCT/IL2016/050778

§ 371 Date: Jan. 26, 2018

(30) Foreign Application Priority Data
Jul. 29, 2015 (IL) 240217

(51) Int. Cl. F16L 55/07; F16K 24/04

(52) U.S. Cl. CPC F16L 55/07; F16L 41/021; F16K 24/048; F16K 24/044

(57) ABSTRACT

Provided is a fluid flow valve including a valve head configured with an inside fluid port being in fluid flow communication with an outside fluid port. The valve head is configurable for coupling at a top portion of a substantially upright tube section. A valve module may be disposed below the valve head and displaceable under fluid pressure along a longitudinal axis between an open position, at which fluid flow is facilitated thorough the valve head, and a sealed position, at which the valve module sealingly engages the inside fluid port to thereby prevent fluid flow through the valve head.

### TECHNOLOGICAL FIELD

The present disclosure relates to fluid flow valves of the type configured on the one hand to allow discharge of trapped gas, and on the other hand allow ingress of gas so as to provide vacuum relief when a line is drained.

### BACKGROUND ART

References considered to be relevant as background to the presently disclosed subject matter are listed below:

U.S. Pat. No. 4,770,201

US2010/108156

Acknowledgement of the above references herein is not to be inferred as meaning that these are in any way relevant to the patentability of the presently disclosed subject matter.

### BACKGROUND

Air purge valves are generally fitted to liquid conduits such as, for example, mains distribution lines or sewage distribution conduits and are designed to ensure the release of air or other gases from the conduits, thereby avoiding the production of air locks, for example, which would interfere with the flow of the liquid.

U.S. Pat. No. 4,770,201 is concerned with a fluid flow valve such as a faucet or air-purge valve comprising a housing having defined therein a fluid through-flow aperture with a valve seating formed in the housing and bounding said aperture. A flexible closure membrane is secured at one end to the housing and is adapted to be biased, under fluid pressure in the housing, against the valve seating so as to seal the aperture. Membrane displacing means are secured to an opposite end of the membrane so that displacement of the displacing means in a first sense progessively detaches successive transverse portions of the membrane from the seating so as to open the aperture while displacement of the displacing means in an opposite sense allows for the membrane to become sealingly biased against the seating.

US2010/108156 discloses a gas purge valve that includes a housing formed with a fluid inlet and a fluid outlet. The fluid outlet is bounded by a kinetic valve seating, and a sealing assembly, which includes a float member coaxially displaceable within the housing, and a sealing cap coupled to said float member. The sealing cap is axially displaceable with respect to the float member between a first position in which it conjoins the float, and a second position in which it departs from the float. The sealing cap is formed at an outside face thereof with a kinetic seal fitted for sealing engagement of the kinetic valve seating, and an automatic valve aperture formed in the sealing cap and bounded by an automatic valve seating. An automatic sealing member articulated is at an upper end of the float member for sealing engagement of the automatic valve seating.

### GENERAL DESCRIPTION

The present disclosure is directed to a fluid flow valve comprising a valve head configured with an inside fluid port being in fluid flow communication with an outside fluid port, said valve head is configurable for coupling at a top portion of a substantially upright tube section; a valve module disposed below said valve head and displaceable under fluid pressure along a longitudinal axis between an open position at which fluid flow is facilitated thorough said valve head, and a sealed position at which the valve module sealingly engages the inside fluid port to thereby prevent fluid flow through the valve head.

In particular the disclosed fluid flow valve is configured to facilitate ingress/egress flow of gaseous material, while prevent liquid flow there through, wherein the valve module opens for gaseous material flow and seals under liquid pressure.

The arrangement of the presently disclosed fluid flow valve is that it is devoid of a housing and is thus configured for encapsulating within a substantially upright tube section, vertically extending from and being in flow communication with a flow line (i.e. the main fluid flow line). The upright tube section can be integral with or articulately coupled to the flow line.

The upright tube section thus facilitates as a pressure body and a capsule for housing and supporting the valve head and the valve module.

According to one configuration of the disclosure, the valve module is a so-called automatic valve and is configured for facilitating fluid discharge of substantially pressurized gaseous material, at substantially low flow rates, whilst preventing liquid flow there through.

According to another configuration of the disclosure the valve module is a so-called kinetic valve and is configured for facilitating gaseous material discharge at substantially high flow rates, though substantially not under pressure.

According to yet another configuration of the disclosure the valve module is a so-called combined valve, i.e. providing features of both an automatic valve and a kinetic valve. A combined valve, offers discharge of sudden bursts of large quantities of gaseous material to be released through the kinetic valve portion, whilst continuous releasing of relatively small amounts of gaseous material through the automatic valve portion.

Another aspect of the disclosure is directed to a fluid flow valve comprising a valve head configured with a fluid inside port being in fluid flow communication with a fluid outside port, said valve head coupled at a top portion of a substantially upright tube section which in turn is in flow communication with a main flow pipe; a valve module disposed below said valve head and displaceable under fluid pressure along a longitudinal axis between an open position at which gaseous material flow is facilitated thorough said valve head, and a sealed position at which the valve module sealingly engages the inside port to thereby prevent fluid flow through the valve head.

The arrangement is such that liquid level in the tube section governs the operative position of the module, wherein liquid level rising within the tube section entails sealing of the valve module to prevent fluid there through.

Any one or more of the following features, designs and configurations can be applied to any aspect of the fluid flow valve subject of the present disclosure, independently or in combinations thereof:
The valve modular can comprise, or be articulated with, a float member;
The fluid flow valve can be configured for articulation to a plain upright tube section, i.e. an upwardly extending tube section having a regular and continuous cross-section;
The fluid flow valve can be a modular unit in the sense that is suitable for retrofit in substantially any upright tube section;
The valve head can be configured in the shape of a plug coupleable to the upright tube section;
The valve head is configured for sealingly coupling within the top portion of a substantially upright tube section. Such sealing can be for example by an O-ring disposed between a portion of the valve head and a top portion of the upright tube section or a coupling member interconnecting same;
The fluid flow valve can be articulated to the upright tube section through a standard screw coupling;
The fluid flow valve can be articulated to the upright tube section by a flange coupling configuration, wherein the valve head is configured with a flanged portion coupleable to a corresponding flange at the top of the upright tube section;
The fluid flow valve can be articulated to the upright tube section by a Bayonet-type coupling, wherein the valve head is configured with a bayonet portion configured for interlocking with a corresponding bayonet portion of the upright tube section;
The fluid flow valve can be articulated to the upright tube section at an internal mounting;
The fluid flow valve can be articulated to the upright tube section at an external mounting, there being further provided a coupling member (e.g. coupling ring) interconnecting between the valve head an external coupling portion (e.g. threading) of the upright tube section;
Axial displacement of the valve module in a downwards sense can be restricted by a valve module support extending from the valve head or from the upright tube section;
The valve module support can be a sealing member articulated at one end to the valve head and at another end to the valve module;
The valve module is typically restrained so as to limit displacement thereof in an axial sense, while prohibiting tilt and roll motion thereof about the longitudinal axis;
A shutoff valve can be articulated on a portion of the upright tube section, below the valve module, to facilitate fluid flow shutoff through said upright tube section, e.g. for mounting and servicing the fluid flow valve;
The valve head can be readily detachably attachable to the upright tube section;
The upright tube section can be a standard tubing member extending from a main pipe section. The upright tube section can be integral with the main pipe section or detachably articulated thereto;
The upright tube section can extend from an intersecting pipe section configured for coupling to the main pipe section (as an intermediate or end piece);
The upright tube section can extend from an elbow-shaped fitting (i.e. at an end of a main pipe section) or from a T-shaped fitting (i.e. intermediate a main pipe section), Such fittings can be for example screw fittings, fast fittings, latch/snap fittings, etc.;
The upright tube section can extend from a boss tube clamp member fitted over a main pipe section;
The upright tube section in its capacity as a pressure body and a capsule for housing and supporting the valve head and the valve module is substantially rigid;
The valve module can comprise a fluid through-flow aperture of the inside fluid port with a valve seating formed at a bottom face of the valve head and bounding the aperture; a flexible closure seal secured at one end to the valve head, and an opposite end of the seal secured to the valve module; the arrangement being such that the displacement of the valve module downwards entails progressive detaching successive transverse portions of the seal from the seating so as to open the aperture whilst displacement of the displacing means upwards allows the seal to become sealingly biased against the seating;
The valve module comprises a float member, or is articulated to a float member, such that the valve module is adapted to be biased, under fluid pressure in upright tube section, against the valve seating so as to seal the aperture;
The seal can be a so-called pealing seal, at times also referred to as a rolling seal.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a perspective view of a main pipe line with an integral upright tube section fitted with a fluid flow valve according to an example of the present disclosure;

FIG. 1B is a perspective sectioned view along line B-B in FIG. 1A;

FIG. 1C is a perspective sectioned view along line C-C in FIG. 1A;

FIG. 1D is a perspective exploded view of FIG. 1A;

FIG. 2A is a vertically sectioned vertical view through the fluid flow valve at an open position thereof;

FIG. 2B is a vertically sectioned view through the fluid flow valve at a closed position thereof;

FIGS. 3A and 3B are a longitudinal sectioned view of a fluid flow valve according to another example, at an open position and a closed position, respectively;

FIG. 3C is a perspective exploded view of the fluid flow valve of FIGS. 3A and 3B;

FIGS. 4A and 4B are a longitudinal sectioned view of a fluid flow valve according to a modification, at an open position and a closed position, respectively.

FIG. 5 is a longitudinal section through a pipe system fitted with a fluid flow valve, wherein a shutoff valve is provided; and

FIG. 6 is a sectioned top portion of a fluid flow valve according to another example of the present disclosure.

### DETAILED DESCRIPTION OF EMBODIMENTS

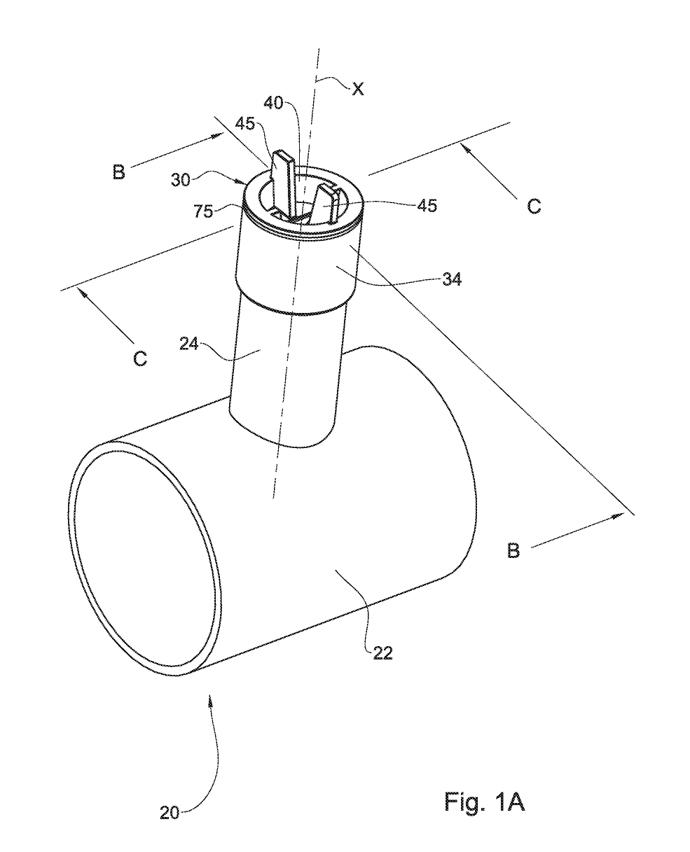

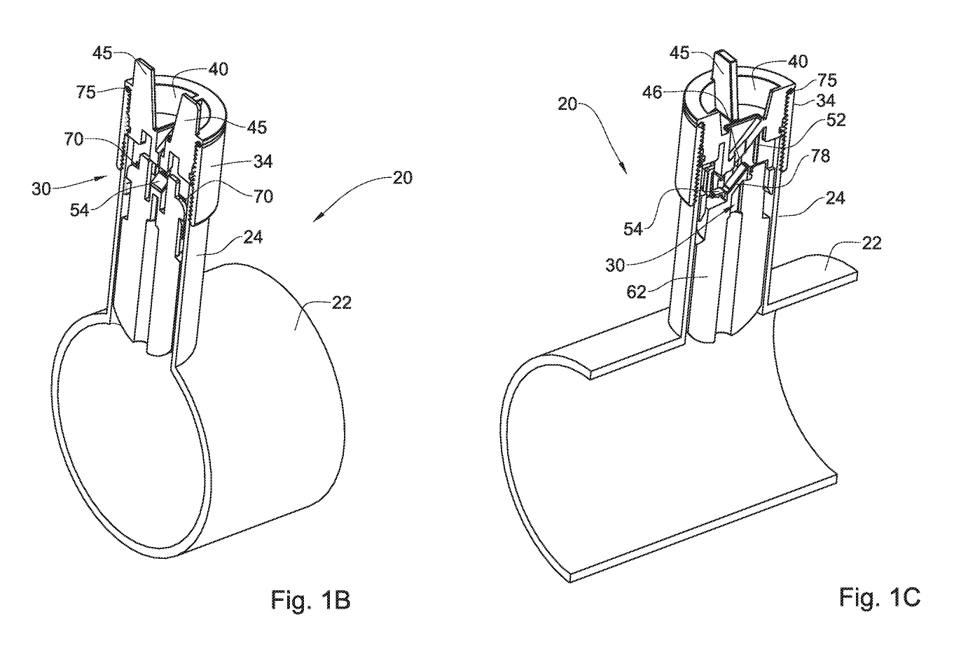

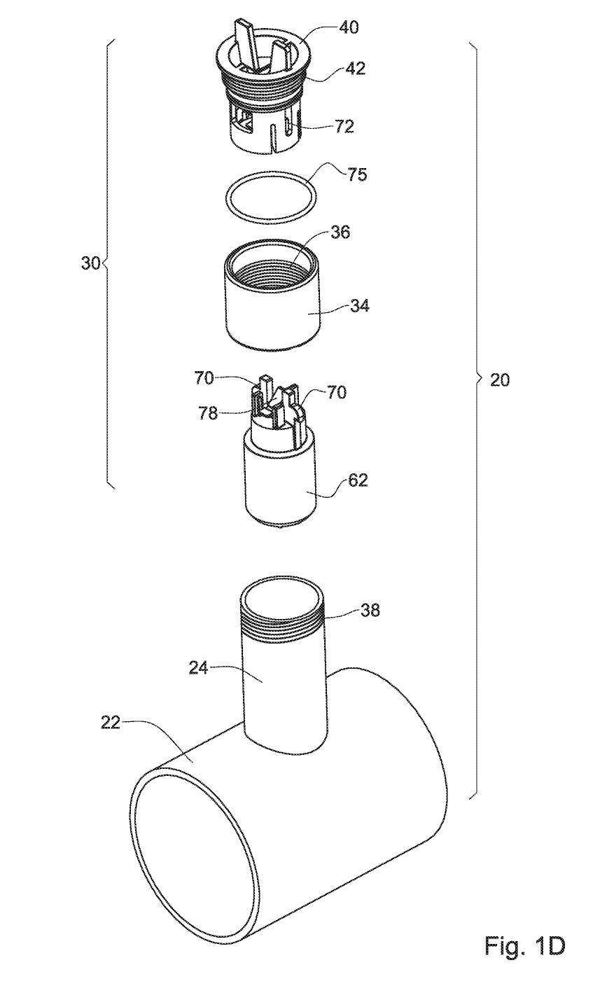

Reference is first being made to FIGS. 1A to 1D of the drawings illustrating a fluid flow valve system according to a first example of the present disclosure, generally designated 20. The system comprises a main pipe line 22, e.g. water supply line, and an upright tube section 24, disposed substantially vertically along a longitudinal axis X, and which in the present example is integrated with main pipe line 22.

A fluid flow valve generally designated 30 is fitted within a top portion of the upright tube section 24 and is securely articulated thereto by a retention ring 34 being internally threaded and configured for screw coupling over corresponding external threading 38 of the upright tube section 24 and for sealingly receiving a valve head 40 of the fluid flow valve 30, by a threading 42 configured for screw coupling with threading 36 of the retention ring 34.

The valve head 40 is a plug-like element and comprises at a top thereof a pair of wing-like members 45 configured to facilitate easy assembly and disassembly of the fluid flow valve 30, e.g. for servicing. It is appreciated that other arrangements can be configured for facilitating assembly and disassembly of the fluid flow valve onto the pipe augment.

The valve head is configured for sealingly coupling within the top portion of the substantially upright tube section 24 by an O-ring 75 disposed between the valve head 40 and the upright tube section 24.

The valve head 40 is further configured with an inside fluid port 46 and an outside fluid port 48 (open to the atmosphere), with a flow channel 50 extending therebetween. The inside fluid port 46 is defined by a fluid through-flow aperture with a valve seating 52 formed at a bottom face of the valve head and bounding the aperture. A flexible closure seal 54 is secured at one end to the valve head 40 at location 56, and an opposite end of the seal 54 is secured at 60 to a valve module 62 disposed within the upright tube section 24 below the valve head 40. The seal 54 is configured for gradually detaching from the valve seating 52. The valve seating 52 is inclined along the longitudinal axis X and as will be discussed hereinafter, serves a sealing surface for the flexible seal 54.

The valve module 62 is a float element axially displaceable within the upright tube section 24 along the longitudinal axis X and is articulated to the valve head 40 by several lateral supports 70 (a pair in the present example; best seen in FIGS. 1B and 1D) projecting into axially extending slots 72 formed in side walls of the valve head 40, thereby preventing the valve module 62 from rotation and restricting its axial displacement along the longitudinal axis.

The valve module 62 is freely slidable within the upright tube section 24, with a clearance 76 residing between the side walls of the float and the inner walls of the upright tube section 24, to facilitate gas flow therethrough.

A top portion of the valve module 62 is configured with a seal support 78 (FIG. 1D), said seal support configured as a surface inclined and oriented in correspondence with the valve seating 52, whereby when the float member 62 is urged upwardly, under fluid pressure within the upright tube section 24, the flexible seal sealingly bears against the valve seating 52 and seals the inside fluid port 46.

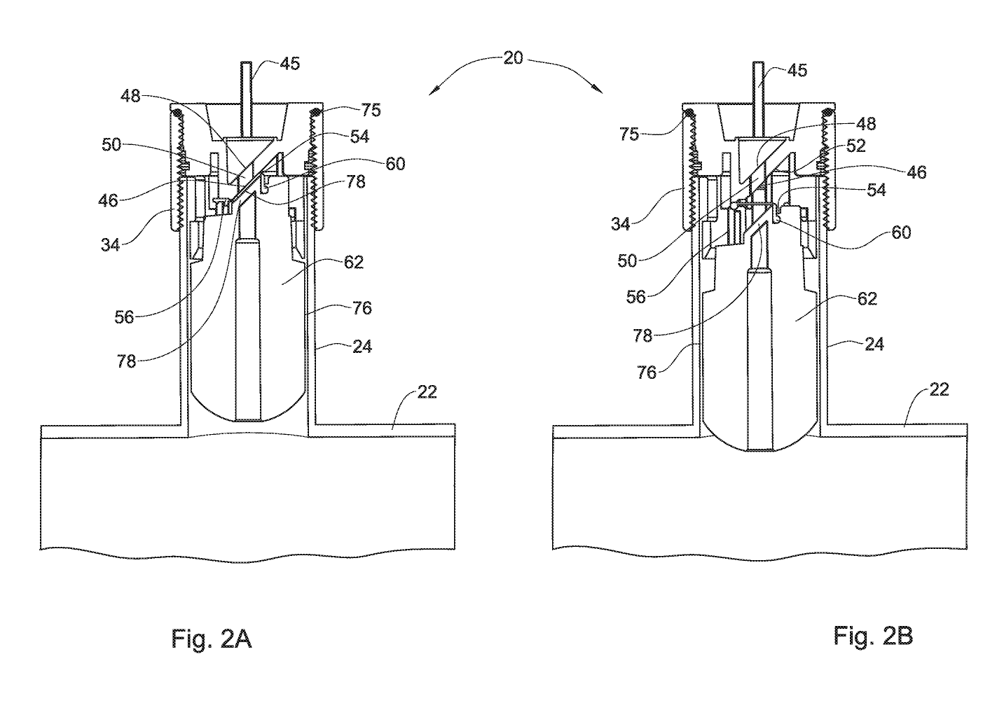

The arrangement is such that at the absence of fluid pressure within the upright tube section 24, the valve module 62 is disposed at its lowermost position under (FIG. 2B) under self weight of the float 62. At this position small amounts of gas can be vented (either ingress or egress) through the clearance 76. However, at the event of liquid rise within the upright tube section 24, the float member 62 is urged upwards (FIG. 2A) resulting in sealing engagement of the closure seal 54 against the valve seating 52, resulting in sealing of the fluid flow valve 30.

At the event of liquid level dropping within the upright tube section 24, the valve module 62 displaces downwards (under its weight), entailing progressive detaching successive transverse portions of the seal 54 from the seating 52, so as to open the aperture of the inside fluid port 46, until the inside fluid port is fully open to facilitate fluid flow also at substantially high flow rates.

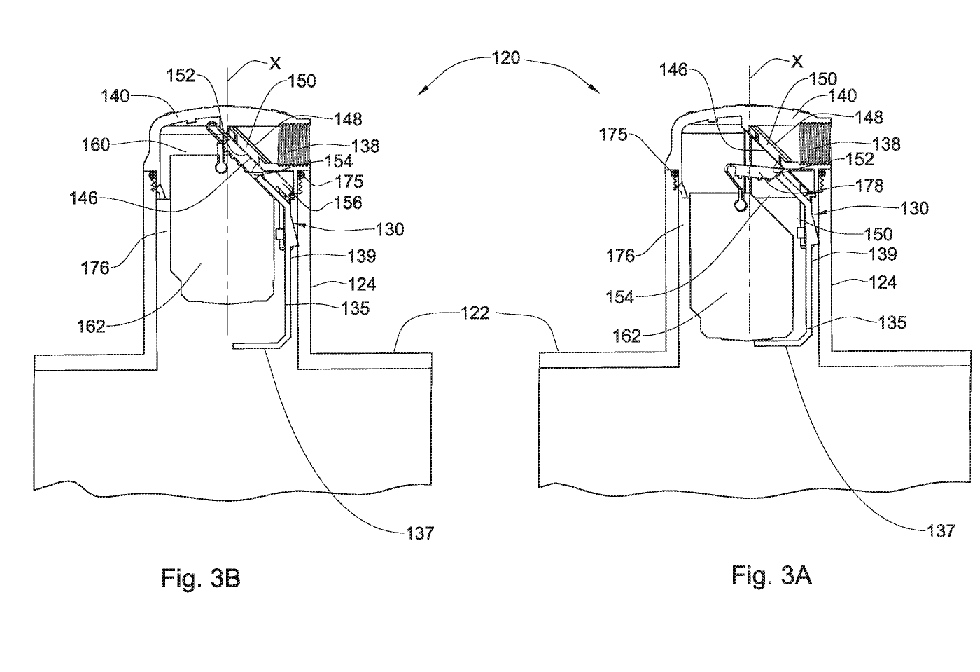

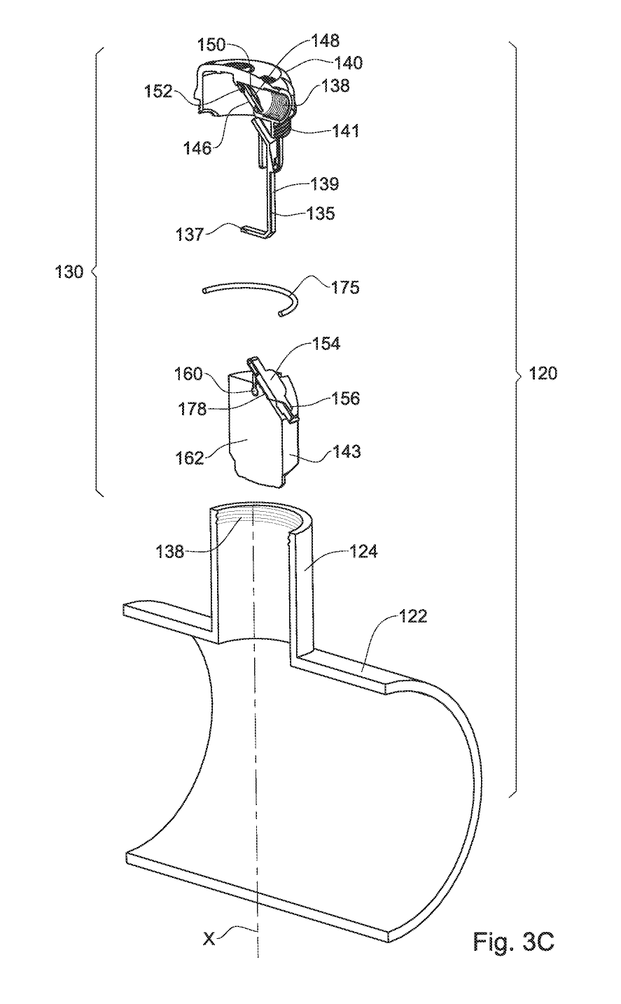

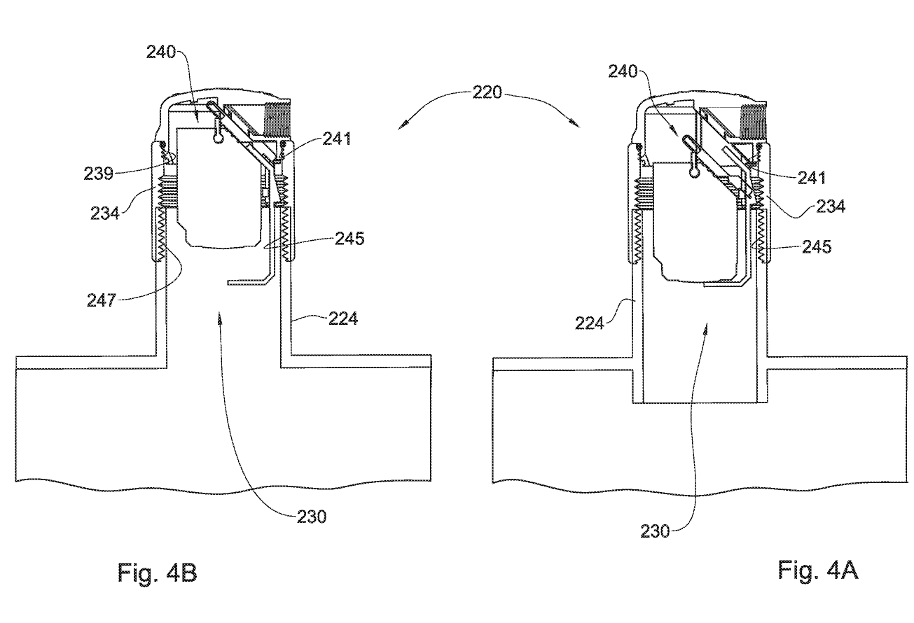

FIGS. 3 and 4 illustrate a fluid flow valve system according to modifications of the present disclosure, wherein for sake of simplicity like elements as in the previous example are designated with like reference numbers, however shifted by 100.

With reference first being made to FIGS. 3A to 3C there is illustrated a fluid flow valve system according to the second example of the present disclosure, generally designated 120. The system comprises a main pipe line 122, and an upright tube section 124, disposed substantially vertically along a longitudinal axis X, and which in the present example is integrated with main pipe line 122.

A fluid flow valve generally designated 130 is fitted within the top portion of the upright tube section 124 and is securely articulated thereto by screw coupling of a valve head 140, through external threading 141, over corresponding internal threading 138 of the upright tube section 124. The valve head 140 is configured for sealingly coupling within the top portion of the substantially upright tube section 124 by an O-ring 175 disposed between the valve head 140 and the upright tube section 124.

The valve head 140 is a plug-like element configured to facilitate easy assembly and disassembly of the fluid flow valve 130, e.g. for servicing.

The valve head 140 is further configured with an inside fluid port 146 and an outside fluid port 148 (open to the atmosphere), with a flow channel 150 extending therebetween. The inside fluid port 146 is defined by a fluid through-flow aperture with a valve seating 152 formed at a bottom face of the valve head 140 and bounding the aperture (inside fluid port 146). An outlet 139 from the valve head 140 extends sideways and is threaded, such that different elements can be secured thereto, e.g. a drain pipe (not shown), a screen (not shown), etc.

A flexible closure seal 154 is secured at one end to the valve head 140 at location 156, and an opposite end of the seal 154 is secured at 160 to a valve module 162 disposed within the upright tube section 124 below the valve head 140. The valve seating 152 is inclined along the longitudinal axis X and as will be discussed hereinafter, serves a sealing surface for the flexible seal 154.

The valve module 162 is a float element axially displaceable within the upright tube section 124 along the longitudinal axis X. a support member in the form of an L-shaped arm 135 is fixedly articulated to the valve head 140 and depends downwards with a short arm portion 137 extending below the float member 162, thereby restricting its downward axial displacement. The long arm portion 139 is flat and resides in a gap configured between the inner wall of the upright tube section 124 and a flattened wall portion 143 (FIG. 3C) of the float member, such that he later is prevented from rotation within the upright tube section 124.

Similar to the arrangement disclosed in connection with the earlier example, the valve module 162 is freely slidable within the upright tube section 124, with a clearance 176 (seen in FIGS. 3A and 3B) residing between the side walls of the float and the inner walls of the upright tube section 124, to facilitate gas flow therethrough.

A top portion of the valve module 162 is configured with a seal support 178, being a surface inclined and oriented in correspondence with the valve seating 152, whereby when the float member 162 is urged upwardly, under fluid pressure within the upright tube section 124, the flexible seal 154 sealingly bears against the valve seating 152 and seals the inside fluid port 146.

The fluid flow valve system 120 with the fluid flow valve 130 function in the same fashion as discussed herein above with reference to FIGS. 1 and 2 namely, at the absence of fluid pressure within the upright tube section 124, the valve module 162 is disposed at its lowermost position under (FIG. 3A) under self weight of the float 162, bearing over the short arm portion 137. At this position small amounts of gas can be vented (either ingress or egress) through the clearance 176. However, at the event of liquid rise within the upright tube section 124, the float member 162 is urged upwards (FIG. 3B) resulting in sealing engagement of the closure seal 154 against the valve seating 152, resulting in sealing of the fluid flow valve 130.

At the event of liquid level dropping within the upright tube section 124, the valve module 162 displaces downwards (under its weight), entailing progressive detaching successive transverse portions of the seal 154 from the seating 152, so as to open the aperture of the inside fluid port 146, until the inside fluid port is fully open to facilitate fluid flow also at substantially high flow rates.

Turning now to FIGS. 4A and 4B of the drawings, there is illustrated a fluid flow valve system 220 being almost similar to that disclosed in connection with the example of FIGS. 3A to 3C, with the only difference residing in the method of articulating the fluid flow valve thereto, and thus the explanation following hereinafter is directed to that aspect only.

In the example of FIGS. 4A and 4B the fluid flow valve 230 is in fact identical with fluid flow valve 130 of the previous example, and comprises a valve head 240 configured with an external threading 241 which is adapted for screw coupling at 239 within a top portion of a coupling ring 234 (resembling ring 34 of FIGS. 1A to 12A), said coupling ring 234 configured at a bottom portion thereof with an internal threading 245 for screw coupling over a corresponding external thread 247 at a top portion of the upright tube section 224.

Apart for that difference, the fluid flow valve 230 operates similar to that disclosed in connection with the previous example.

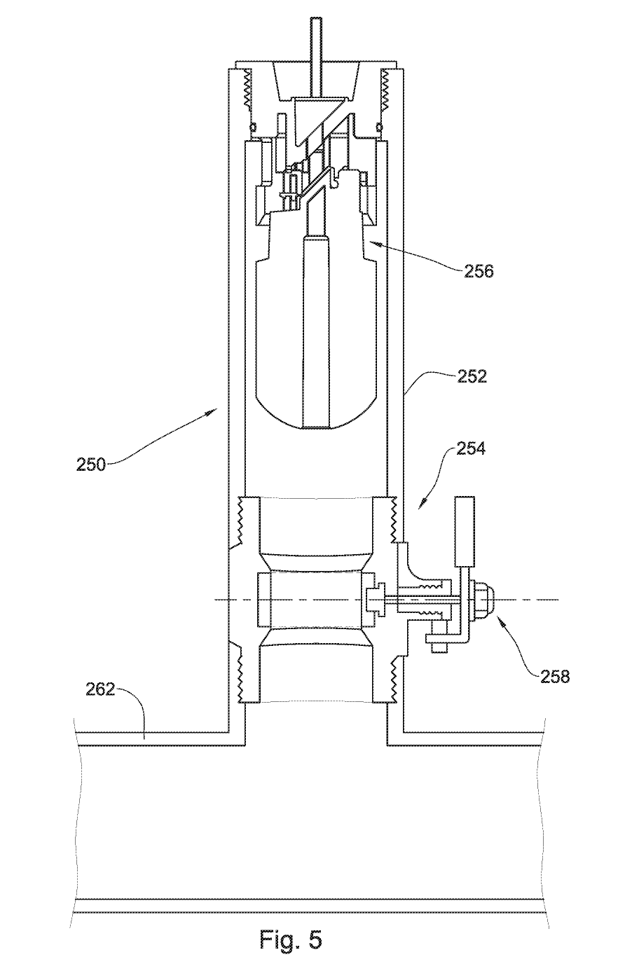

In FIG. 5 there is illustrated a fluid flow valve 250, substantially as disclosed herein above, however wherein the upright tube section 252 is configured with an externally operated shutoff valve 254 disposed below the fluid flow valve generally designated 256. The shutoff valve 254 is configured with an actuator 258 facilitating fluid shutoff through the upright tube section 252, thereby facilitating mounting/dismounting and servicing of the fluid flow valve 256 without affecting flow through the main pipe line 262.

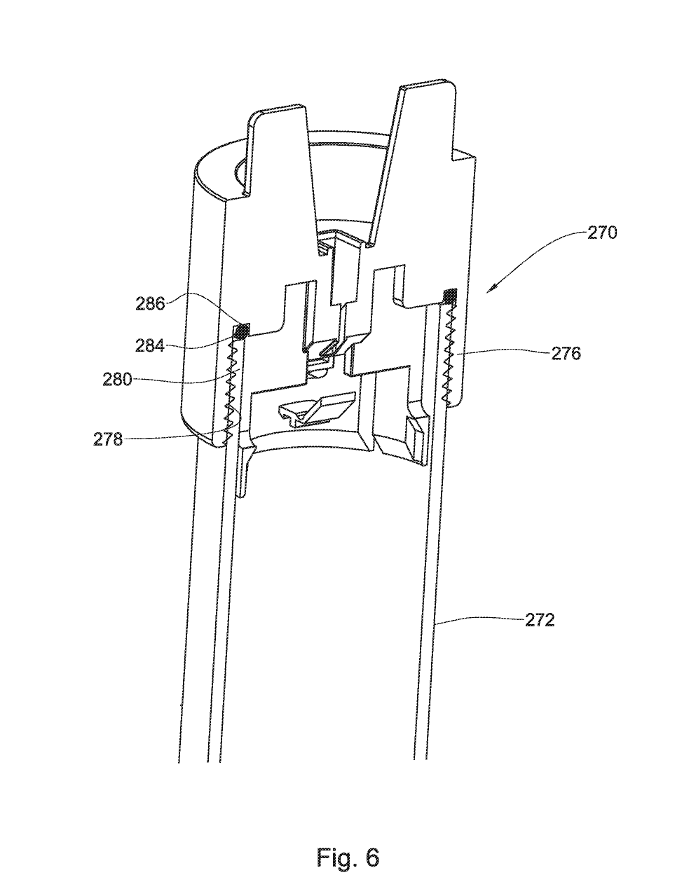

The arrangement of FIG. 6 illustrates a modification of a valve head generally designated 270, which differs from previous examples in the fashion of how it couples to the upright tube section 272. As can be seen, the valve head is integrally configured with a downwardly extending coupling sleeve 276 internally threaded at 278 and configured for screw coupling over a top threaded portion 280 of the upright tube section 272, with a sealing ring 284 disposed between a shoulder 286 of the valve head and a top edge of the upright tube section 272.

1. A fluid flow valve comprising: a valve head configured with an inside fluid port being in fluid flow communication with an outside fluid port, said valve head is configurable for coupling at a top portion of a substantially upright tube section; a valve module disposed below said valve head and displaceable under fluid pressure along a longitudinal axis between an open position at which fluid flow is facilitated thorough said valve head, and a sealed position at which the valve module sealingly engages the inside fluid port to thereby prevent fluid flow through the valve head.

2. A fluid valve according to claim 1, wherein it is devoid of a housing and is configured for encapsulating within an upright tube section, vertically extending from and being in flow communication with a flow line, said upright tube section being integral with or articulately coupled to the flow line.

3. A fluid valve according to claim 2, wherein the valve module is an automatic valve and is configured for facilitating fluid discharge of substantially pressurized gaseous material, at substantially low flow rates, whilst preventing liquid flow there through.

4. A fluid valve according to claim 2, wherein the valve module is a kinetic valve and is configured for facilitating gaseous material discharge at substantially high flow rates, though substantially not under pressure.

5. (canceled)

6. A fluid valve according to claim 2, wherein liquid level in the tube section governs an operative position of the module, wherein liquid level rising within the tube section entails sealing of the valve module to prevent fluid there through.

7. A fluid valve according to claim 2, being a modular unit suitable for retrofit in an upright tube section.

8. A fluid valve according to claim 2, wherein the valve head is configured in the shape of a plug coupleable to the upright tube section.

9. A fluid valve according to claim 2, wherein the valve head is configured for sealingly coupling within the top portion of a substantially upright tube section.

10. A fluid valve according to claim 2, wherein the fluid flow valve is articulated to the upright tube section through a standard screw coupling.

11. A fluid valve according to claim 2, wherein the fluid flow valve is articulated to the upright tube section by a flange coupling configuration, wherein the valve head is configured with a flanged portion coupleable to a corresponding flange at the top of the upright tube section.

12. (canceled)

13. A fluid valve according to claim 2, wherein the fluid flow valve is articulated to the upright tube section at an internal mounting.

14. A fluid valve according to claim 2, articulated to the upright tube section at an external mounting, there being further provided a coupling member interconnecting between the valve head an external coupling portion of the upright tube section.

15. A fluid valve according to claim 1, wherein axial displacement of the valve module in a downwards sense can be restricted by a valve module support extending from the valve head or from the upright tube section.

16. A fluid valve according to claim 15, wherein the valve module support is a sealing member articulated at one end to the valve head and at another end to the valve module.

17.-23. (canceled)

24. A fluid valve according to claim 2, wherein the upright tube section is rigid and thus serves as a pressure body and a capsule for housing and supporting the valve head and the valve module.

25. (canceled)

26. A fluid valve according to claim 1, wherein the valve module comprises a fluid through-flow aperture of the inside fluid port with a valve seating formed at a bottom face of the valve head and bounding the aperture, a flexible closure seal secured at one end to the valve head, and an opposite end of the seal secured to the valve module and where displacement of the valve module in a downwards direction entails progressive detaching successive transverse portions of the seal from the seating so as to open the aperture whilst displacement of the displacing means upwards allows the seal to become sealingly biased against the seating.

27. A fluid valve according to claim 1, wherein the valve module comprises a float member, or is articulated to a float member, such that the valve module is adapted to be biased, under fluid pressure in upright tube section, against the valve seating so as to seal an aperture.

28. A fluid flow valve comprising: a valve head configured with a fluid inside port being in fluid flow communication with a fluid outside port, said valve head coupled at a top portion of a substantially upright tube section which in turn is in flow communication with a main flow pipe, a valve module disposed below said valve head and displaceable under fluid pressure along a longitudinal axis between an open position at which gaseous material flow is facilitated thorough said valve head, and a sealed position at which the valve module sealingly engages the inside port to thereby prevent fluid flow through the valve head.

29. A fluid flow system comprising: a fluid pipe fitted with at least one upright tube section, configured at a top portion thereof with a fluid flow valve comprising a valve head configured with an inside fluid port being in fluid flow communication with an outside fluid port, a valve module disposed below said valve head and displaceable under fluid pressure along a longitudinal axis between an open position at which fluid flow is facilitated thorough said valve head, and a sealed position at which the valve module sealingly engages the inside fluid port to thereby prevent fluid flow through the valve head.

30. A fluid flow system according to claim 29, wherein the fluid flow valve is devoid of a housing and is configured for encapsulating within an upright tube section, vertically extending from and being in flow communication with a flow line, said upright tube section being integral with or articulately coupled to the flow line.
